(19) United States
(12) Patent Application Publication
(10) Pub. No.: US 2019/0392780 A1
(43) Pub. Date: Dec. 26, 2019

(54) METHODS AND SYSTEMS FOR ADJUSTING DISPLAY BRIGHTNESS

(71) Applicant: HONDA MOTOR CO., LTD., Tokyo (JP)

(72) Inventor: Andrew R. HOOVER, West Liberty, OH (US)

(21) Appl. No.: 16/016,164

(22) Filed: Jun. 22, 2018

(51) Int. Cl. G09G 5/10; B60K 35/00

(52) U.S. Cl. CPC G09G 5/10; B60K 35/00; G09G 2320/0626; B60K 2350/2008; G09G 2360/144; B60K 2350/2069; B60K 2350/962; G09G 2380/10

(57) ABSTRACT

Disclosed are methods and systems for adjusting pixels of a display screen in a vehicle. The methods and systems may include determining a position of the sun relative to a position of the vehicle, determining potential incident light rays from the sun striking the display screen based on the position of the sun, and adjusting one or more characteristics of one or more of the pixels of the display screen based on the potential incident light rays.

### TECHNICAL FIELD

The present disclosure relates to methods and systems for adjusting display brightness in a vehicle.

### BACKGROUND

When in operation, vehicles run a number of hardware and software systems, applications, processes, and tasks, among other operations. In order to translate and convey meaningful information to a user, vehicles may display large amounts of data and content in the form of controls, knobs, buttons, screens, etc. As technologies continue to move away from manual operations and analog information conveyance (e.g., physical buttons and knobs) due to the transition to digital systems, display screens have become a popular means of displaying data and other content to a user. Display screens may display vehicle instrumentation information (e.g., information related to vehicle speed and engine performance), cabin accessory information (e.g., information related to heating and cooling of a vehicle cabin), and media information (e.g., navigation and infotainment systems), among other information. As the use of display screens for displaying user and vehicle information has increased, so has the need to provide a clear and unobstructed view of the display screens. For many vehicle users, glare from the sun, among other factors, may prevent a user from properly viewing content on a display screen.

Therefore, there is a need in the art for methods and systems for adjusting a display screen in a vehicle.

### SUMMARY

The following presents a summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

In an example, a system of a vehicle is provided. The system may include a memory storing instructions for adjusting one or more pixels of a display screen of the vehicle. The system may also include one or more processors coupled with the memory and configured to execute the instructions. The one or more processors may determine a position of the sun relative to a position of the vehicle. The one or more processors may also determine potential incident light rays from the sun striking a display screen of the vehicle based on the position of the sun. The one or more processors may further adjust one or more characteristics of one or more pixels of the display screen based on the potential incident light rays.

In another example, a method for adjusting pixels of a display screen in a vehicle is provided. The method may include determining a position of the sun relative to a position of the vehicle. The method may also include determining potential incident light rays from the sun striking the display screen based on the position of the sun. The method may further include adjusting one or more characteristics of one or more of the pixels of the display screen based on the potential incident light rays.

In another example, a computer-readable medium storing executable code for adjusting pixels of a display screen in a vehicle is provided. The computer-readable medium may include code to determine a position of the sun relative to a position of the vehicle. The computer-readable medium may also include code to determine potential incident light rays from the sun striking the display screen based on the position of the sun. The computer-readable medium may further include code to adjust one or more characteristics of one or more pixels of the display screen based on the potential incident light rays.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIGS. 1A and 1B illustrates an example of a portion of a display screen according to one aspect of the disclosure;

FIG. 2 illustrates a schematic view of an example operating environment of a display adjustment system according to one aspect of the disclosure;

FIG. 3 illustrates a flowchart illustrating an example method for adjusting a display screen according to one aspect of the disclosure;

FIG. 4 presents an example system diagram of various hardware components and other features according to one aspect of the disclosure; and

FIG. 5 is a block diagram of various example system components according to one aspect of the disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “bus,” as used herein, may refer to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area Network (CAN), Local Interconnect Network (LIN), among others.

The term “electronic vehicle,” as used herein, may refer to any moving vehicle that is capable of carrying one or more human occupants and is powered by an electronic battery and/or any form of energy that may be recharged at a charging station. The term “vehicle” may include, but is not limited to: cars, trucks, vans, minivans, SUVs, motorcycles, scooters, boats, personal watercraft, and aircraft.

The term “memory,” as used herein, may include volatile memory and/or nonvolatile memory. Non-volatile memory may include ROM (read only memory), PROM (programmable read only memory), EPROM (erasable PROM) and EEPROM (electrically erasable PROM). Volatile memory may include RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, may include a connection by which entities are “operably connected”, is one in which signals, physical communications, and/or logical communications may be sent and/or received. An operable connection may include a physical interface, a data interface and/or an electrical interface.

The term “processor,” as used herein, may refer to a device that processes signals and performs general computing and arithmetic functions. Signals processed by the processor may include digital signals, data signals, computer instructions, processor instructions, messages, a bit, a bit stream, or other computing that may be received, transmitted and/or detected. A processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “vehicle system,” as used herein, may refer to an electronically controlled system on a vehicle operable to perform certain actions on components of the vehicle, which may provide an interface to allow operation by another system or graphical user interaction. The vehicle systems may include, but are not limited to, vehicle ignition systems, vehicle conditioning systems (e.g., systems that operate a windshield wiper motor, a windshield washer fluid motor or pump, a defroster motor, heating, ventilating, and air conditioning (HVAC) controls, etc.), vehicle audio systems, vehicle security systems, vehicle video systems, vehicle infotainment systems, vehicle telephone systems, and the like.

The term “vehicle applications” or “applications,” as used herein, may refer to any software run by the vehicle system, which may provide information or data to a user of the vehicle, or may receive information or data from a user of a vehicle. The vehicle applications may be displayed on the screen and may include, but are not limited to, navigation, radio, telephone, settings, electric charging, status information, cameras, web browsers, e-mail, games, utilities, and the like.

The term “graphical user interface,” “GUI,” or “user interface,” as used herein, may refer to a type of interface that allows users to interact with electronic devices, the vehicle system, the vehicle, vehicle applications or the like, through graphical icons, visual indicators such as secondary notation, text-based, type command labels, text navigation, and the like.

The term “screen,” “display screen,” or “display,” as used herein, may refer to a surface area upon which text, graphics and video are temporarily made to appear for human viewing. These may include, but are not limited to, eidophor, electroluminescent display (“ELD”), electronic paper, e-Ink, gyricon, light emitting diode display (“LED”), cathode ray tube (“CRT”), liquid-crystal display (“LCD”), plasma display panel (“PDP”), digital light processing (“DLP”), and the like.

The term “communications device,” as used herein, may refer to a device that facilitates intercommunication among vehicle systems, communication with the vehicle systems via one or more other systems or devices, etc. In an example, communication device may interface with other systems, such as a remote device, other computers, etc., via a wireless communication technology, such as a cellular technology, Bluetooth, etc. using a corresponding modem or transceiver.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of certain systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

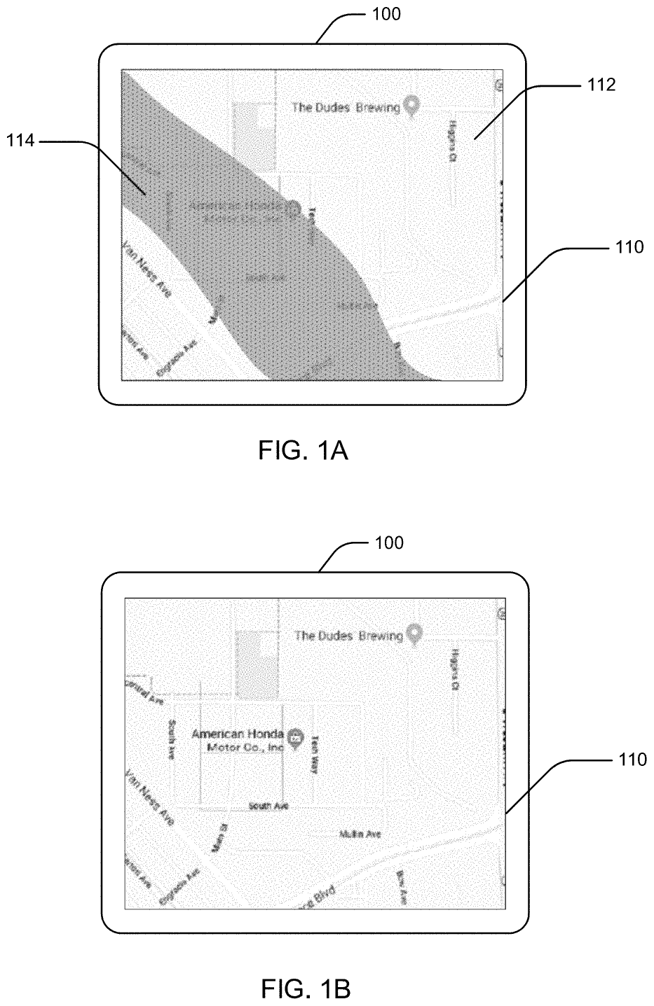

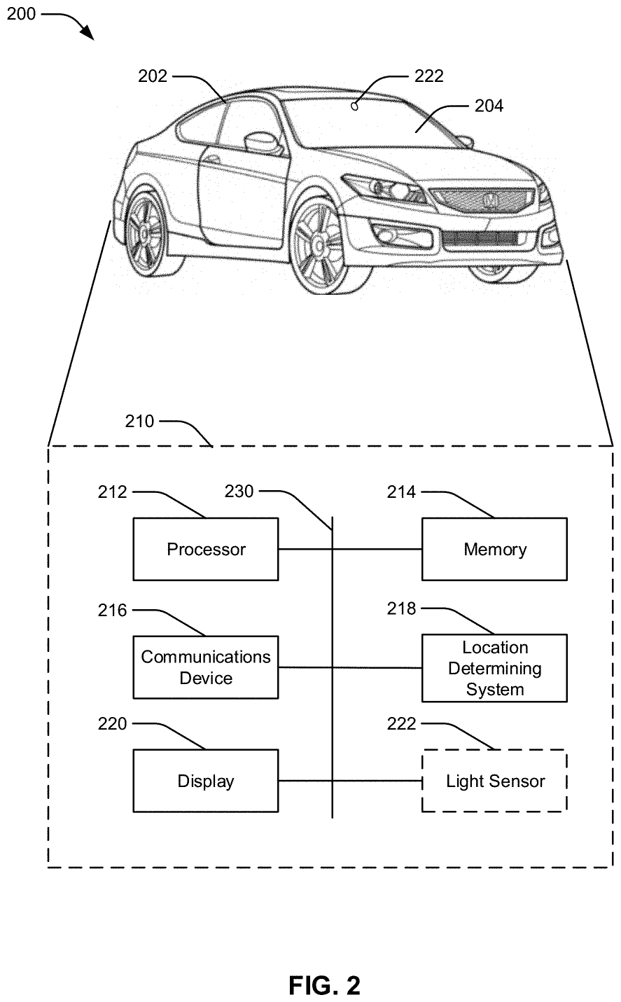

Referring to FIGS. 1A-1B, examples of an image 110 of the display 100 are shown therein. As shown by FIGS. 1A-1B, the display 100 may be configured to display the image 110 related to one or more vehicle systems (e.g., navigation system, infotainment system). While the image 110 is being displayed, light rays from the sun may create a glare on a portion 114 of the display 100. Due to the glare, the portion 114 of the display 100 may be difficult to view while a remaining portion 112 of the display 100 may be viewed without problems. According to aspects of the present disclosure, a display adjustment system 210 (see FIG. 2) may be configured to adjust one or more characteristics of one or more pixels associated with the portion 114 of the display 100 such that the glare from the sun is mitigated or has little or no effect on the portion 114 of the display 100, as illustrated by FIG. 1B.

FIG. 2 shows a schematic view of an example of an operating environment 200 of the display adjustment system 210 and example methods according to aspects described herein. The operating environment 200 may include a vehicle 202, within which the display adjustment system 210 may at least partially reside and/or be implemented. Components of the display adjustment system 210, as well as the components of other systems, hardware architectures and software architectures discussed herein, may be combined, omitted or organized into different architectures for various aspects of the disclosure. However, the example aspects and configurations discussed herein focus on the operating environment 200 as illustrated in FIG. 2, with corresponding system components and related methods.

The display adjustment system 210 may include or be operably coupled with (or executed by) one or more processors 212 and memory 214 that communicate to effectuate certain functions or actions, as described herein. The one or more processors 212 may be configured to execute instructions or code stored on the memory 214. In an implementation, the instructions or code may include instructions or code for adjusting pixels of a display 220, as described herein.

The display adjustment system 210 may additionally include or be operably coupled with a communications device 216, which may include substantially any wired or wireless device, or related modem, etc., for providing wired or wireless communications utilizing various protocols to send/receive electronic signals internally to features and systems within the vehicle 202 and/or to external devices. In an example, the communications device 216 may communicate using one or more radio technologies (e.g., 3GPP radio access technologies, IEEE 802.11, Bluetooth®, etc.).

The display adjustment system 210 may additionally include or be operably coupled with a location determining system 218 for determining a location/position of the vehicle 202 relative to the sun. For example, the location determining system 218 may determine one or more location-related parameters, such as location, position, speed, acceleration, direction, of the vehicle 202. In some examples, the location determining system 218 may include or may be operably coupled with a global positioning system (“GPS”) device (or other latitude/longitude determination device), a speedometer, an accelerometer, a gyroscope, and/or the like, to determine the location-related parameters.

Additionally, the display adjustment system 210 may include or be operably coupled with a display 220 (interchangeably referred to herein as a screen) for displaying vehicle information (e.g., tachometer, speedometer, fuel gauge, heating/cooling), infotainment information (e.g., radio, media files, navigation system), and/or any other information or applications related to one or more vehicle systems. An example of the display 220 may include the display 100 of FIGS. 1A-B. In some examples, the display 220 may include a liquid crystal display (LCD) and/or variants thereof, plasma display, etc., and/or may be part of a touchscreen display.

In an aspect, the display 220 may include an array of pixels for generating an image (e.g., 110 of FIGS. 1A-B) on the display 220. The display 220 may also include components, such as circuits and/or software, for individually driving each pixel of the array of pixels. The components may also be configured to adjust different characteristics of each pixel, such as one or more of color, brightness, backlight, shade, intensity, or any other displayable characteristic of a pixel. In some examples, the display 220 may be configured to accept inputs from a user regarding selections or preferences of the user via a graphical user interface (GUI).

The display adjustment system 210 may additionally include or be operably coupled with a light sensor 222 for determining an amount of ambient light of the vehicle 202. For example, as illustrated by FIG. 2, the light sensor 222 may be installed on or near a windshield 204 of the vehicle 202 for determining an amount of light from the sun. In other examples, the light sensor 222 may be located within an interior of the vehicle 202 and may determine an amount of ambient light within the interior of the vehicle 202. Examples of the light sensor 222 may include one or more ambient light detecting sensors, such as photoresistor, photoconductive, photovoltaic, or photojunction sensors.

In some examples, the various components of the display adjustment system 210 may be operably coupled to one another via one or more busses 230 to facilitate communication among the components to perform functions described herein. Moreover, one or more of the components described for the display adjustment system 210 may be part of another system. For example, one or more of the processors 212, the memory 214, the communications device 216, the location determining system 218, the display 220, or the light sensor 222 may be part of one or more of an infotainment system, a navigation system, or safety system of the vehicle 202.

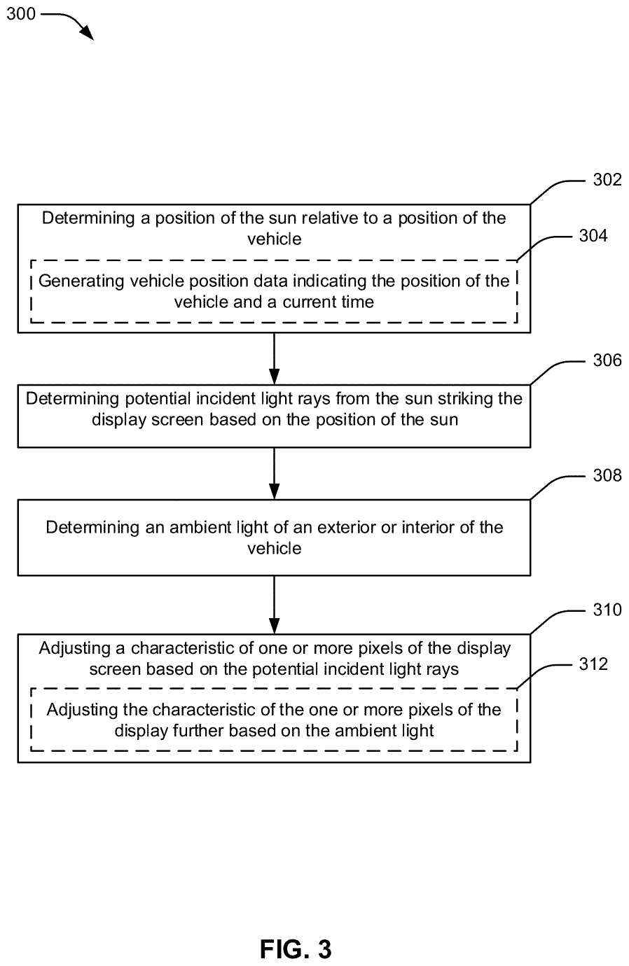

Referring to FIG. 3, a method 300 for adjusting one or more pixels of the display 220 is shown therein. In an example, the method 300 may be performed by the operating environment 200 of FIG. 2. At block 302, the method 300 may include determining a position of the sun relative to a position of the vehicle. For example, the processor 212 may determine a position of the sun relative to position of the vehicle 202. Determining the position of the sun may include, at block 304, generating vehicle position data indicating the position of the vehicle and a current time. For example, the location determining system 218 may determine a location/position of the vehicle 202. In an example, the location/position of the vehicle 202 may be obtained through the use of one or more of the GPS device, speedometer, accelerometer, gyroscope and/or the like to determine location-related parameters. The processor 212 may obtain the vehicle position data generated by the location determining system 218 may and determine a position of the sun relative to the position of the vehicle 202 based on the vehicle position data.

In some examples, the position of the sun may be determined through the use of a lookup table (LUT) stored in the memory 214. The LUT may include information on the position of the sun based on the determined location/position of the vehicle 202 and current time.

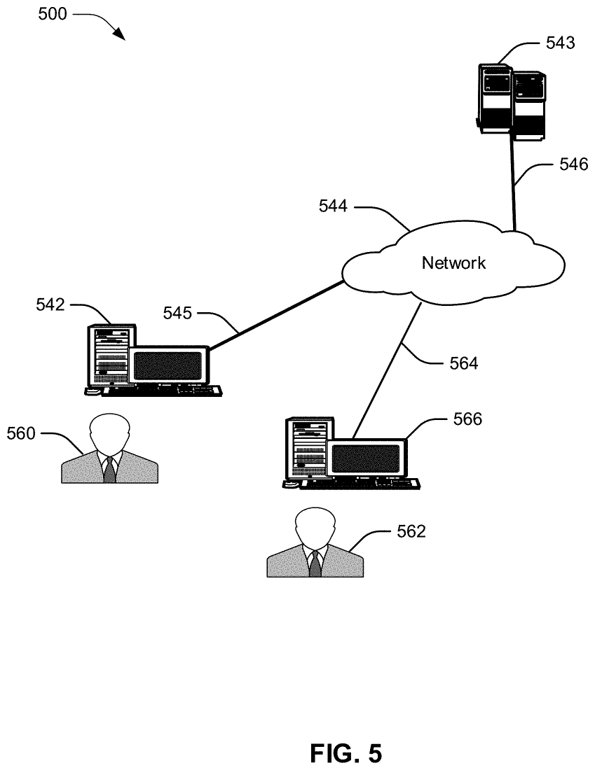

In some examples, the processor 212 may use the communications device 216 to determine the position of the sun. For example, the processor 212, via the communications device 216, may provide the determined location/position of the vehicle 202 and current time to a location server or the Internet (see FIG. 5) and receive the position of the sun in response.

At block 306, the method 300 may also include determining potential incident light rays from the sun striking the display screen based on the position of the sun. For example, the processor 212 may determine potential incident light rays from the sun striking the display 220 based on the position of the sun. The potential incident light rays from the sun may be based on three-dimensional properties of the vehicle 202. The three-dimensional properties may include information generated during three-dimensional modeling of the vehicle 202, for example, light modeling performed during three-dimensional modeling of the vehicle 202 (or prototypes of the vehicle 202) generated during the design and manufacturing of the vehicle 202. The information may include results of modeling interactions of light rays from the sun based on a position of the sun in relation to a three-dimensional model of the vehicle 202. The information may include interactions of the light rays with an exterior and interior of the vehicle 202. This information may include reflection, refraction, and diffraction of sunlight in relation to the exterior and interior of the vehicle 202. For example, the information may include potential incident light rays on the display 220 resulting from the reflection and/or refraction of light rays associated with the windshield 204. In another example, the information may include potential incident light rays on the display 220 resulting from the reflection, refraction, and/or diffraction of light rays associated with a side view mirror, a hood, a sunroof, a roof, or any other portion of the vehicle 202.

In some examples, the three-dimensional properties may be stored in memory 214 (e.g., LUT) or obtained, by the processor 212 via the communication device 216, from a server or the Internet (see e.g., FIG. 5). In some examples, the processor 212 may calculate the three-dimensional properties based on algorithms for determining incident light through reflection, refraction, and diffraction.

At block 308, the method 300 may optionally include determining an ambient light of an exterior or interior of the vehicle. For example, the processor 212 may obtain ambient light information from the light sensor 222. The ambient light information may include information related to ambient light detected by the light sensor 222 on the exterior and/or the interior of the vehicle 202.

At block 310, the method 300 may further include adjusting one or more characteristics of one or more pixels of the display screen based on the potential incident light rays. For example, the processor 212 be configured to adjust a characteristic of one or more pixels of the display 220 based on the potential incident light rays. Adjustable characteristics of a pixel may include one or more of color, brightness, backlight, shade, intensity, or any other displayable characteristic of a pixel in the display 220. In some examples, the processor 212 may control circuits and/or software of the display 220 such that each pixel of the display 220 may be controlled by the processor 212. In an example, the processor 212 may control the pixels associated with the portion 114 of the display 100 and adjust these pixels such that the glare from potential light rays is mitigated or has no effect on the display 100.

In some aspects, at block 312, the method 300 may optionally include adjusting the one or more characteristics of the one or more pixels of the display further based on the ambient light. For example, the processor 212 may adjust one or more characteristics of one or more pixels of the display 220 based on the potential incident light rays and the ambient light detected by the light sensor 222.

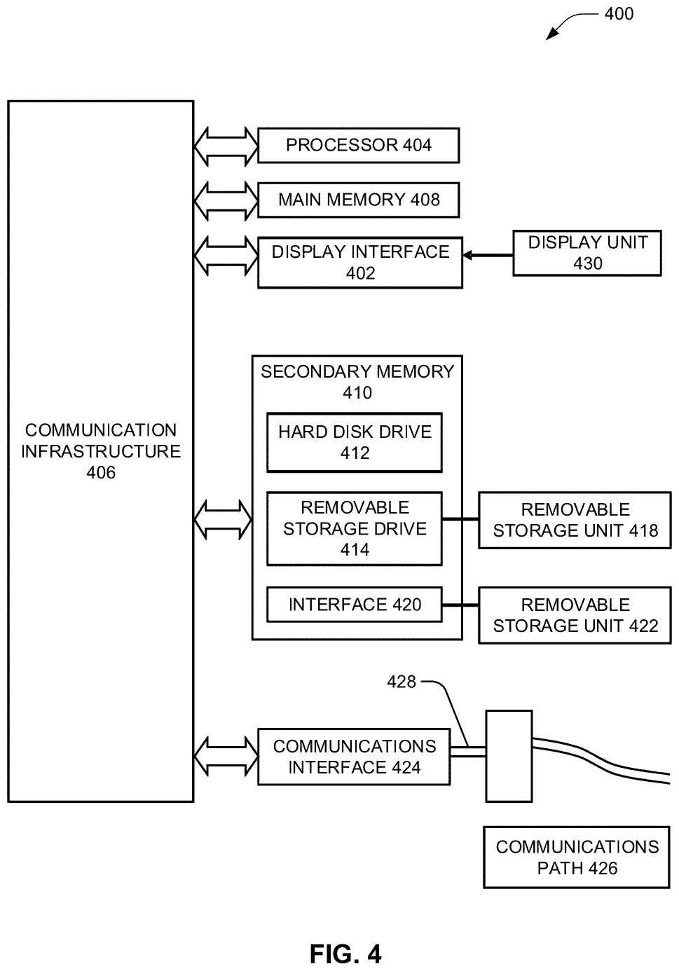

Referring to FIG. 4, an example system is presented with a diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system 400 is shown in FIG. 4.

The computer system 400 may include one or more processors, such as processor 404. The processor 404 is connected to a communication infrastructure 406 (e.g., a communications bus, cross-over bar, or network). The processor 404 may be an example of the processor 212. Various software aspects are described in terms of this example computer system 400. After reading this description, it will become apparent to a person skilled in the relevant art(s) how to implement aspects described herein using other computer systems and/or architectures.

The computer system 400 may include a display interface 402 that forwards graphics, text, and other data from the communication infrastructure 406 (or from a frame buffer not shown) for display on a display unit 430. The display unit 430 may be an example of the display 220. The computer system 400 may also include a main memory 408, e.g., random access memory (RAM), and may also include a secondary memory 410. The secondary memory 410 may include, e.g., a hard disk drive 412 and/or a removable storage drive 414, representing a floppy disk drive, a magnetic tape drive, an optical disk drive, etc. The removable storage drive 414 may read from and/or write to a removable storage unit 418 in a well-known manner. The removable storage unit 418, represents a floppy disk, magnetic tape, optical disk, etc., which is read by and written to the removable storage drive 414. As will be appreciated, the removable storage unit 418 may include a computer usable storage medium having stored therein computer software and/or data.

In alternative aspects, the secondary memory 410 may include other similar devices for allowing computer programs or other instructions to be loaded into the computer system 400. Such devices may include, e.g., a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to the computer system 400. The memory 214 may include one or more of the main memory 408, the secondary memory 410, the removable storage drive 414, the removable storage unit 418, or the removable storage unit 422.

The computer system 400 may also include a communications interface 424. The communications interface 424 may allow software and data to be transferred between the computer system 400 and external devices. Examples of the communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by the communications interface 424. These signals 428 are provided to the communications interface 424 via a communications path (e.g., channel) 426. This path 426 carries signals 428 and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals 428. These computer program products provide software to the computer system 400. Aspects described herein may be directed to such computer program products. In an example, the communications device 216 may include the communications interface 424.

Computer programs (also referred to as computer control logic) may be stored in the main memory 408 and/or the secondary memory 410. The computer programs may also be received via the communications interface 424. Such computer programs, when executed, enable the computer system 400 to perform various features in accordance with aspects described herein. In particular, the computer programs, when executed, enable the processor 404 to perform such features. Accordingly, such computer programs represent controllers of the computer system 400. The computer programs may include instructions or code for executing methods of the display adjustment system 210.

In variations where aspects described herein are implemented using software, the software may be stored in a computer program product and loaded into the computer system 400 using the removable storage drive 414, the hard disk drive 412, or the communications interface 420. The control logic (software), when executed by the processor 404, causes the processor 404 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

FIG. 5 is a block diagram of various example system components. FIG. 5 shows a communication system 500 including one or more accessors 560, 562 (also referred to interchangeably herein as one or more “users”) and one or more terminals 542, 566. The terminals 542, 566 may include the vehicle 202 or a related system (e.g., display adjustment system 210, the processor 212, the communications device 218, etc.), and/or the like. In one aspect, data for use in accordance with aspects described herein may be input and/or accessed by the accessors 560, 562 via the terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, a network 544 for instance, such as the Internet or an intranet, and couplings 545, 546, 564. The couplings 545, 546, 564 may include wired, wireless, or fiberoptic links. In another example variation, the method and system in accordance with aspects described herein operate in a stand-alone environment, such as on a single terminal.

The aspects discussed herein may also be described and implemented in the context of computer-readable storage medium storing computer-executable instructions. Computer-readable storage media includes computer storage media and communication media, and may be, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A system comprising:
a memory storing instructions;
one or more processors coupled with the memory and configured to execute the instructions to:
determine a position of the sun relative to a position of a vehicle;
determine potential incident light rays from the sun striking a display screen of the vehicle based on the position of the sun; and
adjust one or more characteristics of one or more pixels of the display screen based on the potential incident light rays.

2. The system of claim 1, wherein the one or more processors determines the potential incident light rays of the sun striking the display screen further based on three-dimensional properties of the vehicle.

3. The system of claim 2, wherein the three-dimensional properties of the vehicle include information associated with three-dimensional modeling of an exterior and interior of the vehicle.

4. The system of claim 3, wherein the information includes reflection, refraction, and diffraction of sunlight in relation to the exterior and interior of the vehicle.

5. The system of claim 1, further comprising:
a location determining system configured to generate vehicle position data indicating the position of the vehicle and a current time, wherein the one or more processors determines the position of the sun relative to the position of the vehicle based on the vehicle position data.

6. The system of claim 1, wherein the one or more characteristics of the one or more pixels is a color or a lighting of the one or more pixels.

7. The system of claim 1, further comprising an ambient light sensor configured to determine an ambient light in an exterior or an interior of the vehicle, wherein the one or more characteristics of one or more pixels of the display screen is adjusted further based on the ambient light.

8. A method for adjusting pixels of a display screen in a vehicle, comprising:
determining a position of the sun relative to a position of the vehicle;
determining potential incident light rays from the sun striking the display screen based on the position of the sun; and
adjusting one or more characteristics of one or more of the pixels of the display screen based on the potential incident light rays.

9. The method of claim 8, wherein the determining the potential incident light rays from the sun striking the display screen is based on three-dimensional properties of the vehicle.

10. The method of claim 9, wherein the three-dimensional properties of the vehicle include information associated with three-dimensional modeling of an exterior and interior of the vehicle.

11. The method of claim 10, wherein the information includes reflection, refraction, and diffraction of sunlight in relation to the exterior and interior of the vehicle.

12. The method of claim 8, further comprising:
generating vehicle position data indicating the position of the vehicle and a current time, wherein the determining the position of the sun relative to the position of the vehicle is based on the vehicle position data.

13. The method of claim 8, wherein the one or more characteristics of the one or more pixels is a color or a lighting of the one or more pixels.

14. The method of claim 8, further comprising determining an ambient light of an exterior or interior of the vehicle, wherein the one or more characteristics of the one or more pixels of the display screen is adjusted further based on the ambient light.

15. A computer-readable medium storing executable code for adjusting pixels of a display screen in a vehicle, comprising code to:
determine a position of the sun relative to a position of the vehicle;
determine potential incident light rays from the sun striking the display screen based on the position of the sun; and
adjust one or more characteristics of one or more pixels of the display screen based on the potential incident light rays.

16. The computer-readable medium of claim 15, wherein the potential incident light rays from the sun striking the display screen are determined based on three-dimensional properties of the vehicle.

17. The computer-readable medium of claim 16, wherein the three-dimensional properties of the vehicle include information associated with three-dimensional modeling of an exterior and interior of the vehicle.

18. The computer-readable medium of claim 17, wherein the information includes reflection, refraction, and diffraction of sunlight in relation to the exterior and interior of the vehicle.

19. The computer-readable medium of claim 15, further comprising code to:
generate vehicle position data indicating the position of the vehicle and a current time, wherein the position of the sun relative to the position of the vehicle is determined based on the vehicle position data.

20. The computer-readable medium of claim 15, wherein the one or more characteristics of the one or more pixels is a color or a lighting of the one or more pixels.
